(19) United States
(12) Patent Application Publication
(10) Pub. No.: US 2003/0172871 A1
(43) Pub. Date: Sep. 18, 2003

(54) Device and method for internal coating of a pipe

(76) Inventor: Oswald Scherer, Lahnau (DE)

Correspondence Address: FLYNN THIEL BOUTELL & TANIS, P.C., 2026 RAMBLING ROAD, KALAMAZOO, MI, 49008-1699, US

(21) Appl. No.: 10/382,053

(22) Filed: Mar. 5, 2003

(30) Foreign Application Priority Data
Mar. 5, 2002 (DE) 102 09 485.3

(51) Int. Cl. B05D 7/22; B05D 1/02

(52) U.S. Cl. 118/306; 427/236; 427/421

(57) ABSTRACT

This invention relates to a method and a device (01) for coating the interior wall (14) of a pipe (02) with a curable compound, a spraying device (04) being provided on the device (01) by means of which a directed stream (10) of curable compound can be produced. A centrifugal device (05) which is driven to rotate is provided on the device (01), the stream (10) of the curable compound being directed at the centrifugal device (05), so that the curable compound is thrown by the centrifugal device (05) against the inside wall (14) of the pipe (02) because of the rotational force produced by the rotation.

This invention relates to a device and a method for internal coating of a pipe according to the preamble of the independent patent claims.

Generic devices and methods can be used in renewal of pipelines, but also in the manufacture of new pipes. The pipeline network is old and fragile in many locations, so there is an urgent need for renewal because of the resulting leakage.

The object of the present invention is therefore to propose a new device and a new method of coating the interior of pipes with a curable compound.

Advantageous embodiments of this invention are the object of the subclaims.

And advantage of the present device is in particular the fact that the stream of curable compound which yields the desired interior coating of the pipe after it has cured, is directed at a centrifugal device which is driven to rotate. After impact of the curable compound on the centrifugal device, the curable compound is then thrown against the inside surface of the pipe by the centrifugal device because of the centrifugal forces produced by the rotation. Due to this method of distributing the curable compound, an extremely uniform coating can be produced on the inside of the pipe. In addition, it is possible to process curable compounds which cure within a very short pot life.

Essentially any design of the drive motor for driving the centrifugal device is possible. For example, drive motors operated hydraulically or by electric motor are conceivable. It is especially advantageous to use a drive motor driven with compressed air or a similar hydraulic medium, because very high rotational speeds can be achieved with these drive motors.

The coating result when using the device according to this invention also depends to a significant extent on the distance between the centrifugal device and the spraying device. In order for the device according to this invention to be set for different boundary conditions, it is therefore especially advantageous if the distance between the centrifugal device and the spraying device is variable.

The rotational speed of the centrifugal device is another important operating parameter. Therefore, the rotational speed of the centrifugal device should also be variable so that different boundary conditions of the coating can be optimally satisfied.

In addition, the velocity of flow of the curable compound, measured as the outlet velocity at the spray device, for example, or as the impact velocity at the centrifugal device should also be variable. This may be accomplished by varying the delivery pressure with which the curable compound, i.e., the various components of which the curable compound is prepared is pumped into the spraying device.

To be able to deposit a continuous internal coating on the inside of the pipe, the spraying device must be moved relative to the pipe. To do so, a conveyor device, e.g., a robot mimic or a pipe mouse which can travel in the pipe may be provided according to this invention. It is especially advantageous if the conveyor device can be operated by remote control to thus permit remote-controlled coating of the pipe. In particular, this makes it possible for the operating personnel to perform the coating from outside the pipe.

To be able to monitor the coating results in the pipe at any time, an observation unit, which is designed in the manner of a video camera in particular, may be provided on the device. The images picked up by the video camera are then transmitted to a display device, e.g., a monitor outside the pipe, so that the operating personnel can inspect the coating results.

The centrifugal device may have essentially any structural design. For example centrifugal devices in the form of a cone or a truncated cone are conceivable, where the stream of curable compound is directed at the conical surface. Especially uniform coating results are achieved when the centrifugal device is designed in the manner of a face wheel, which is driven to rotate about the midpoint of its bottom.

When using such a face wheel, the stream of curable compound may then be directed at the face wheel in such a way that the stream strikes the face wheel essentially at the bottom of the face wheel and/or a drive shaft situated on the bottom. Due to this special relative kinematics between the stream and the face wheel, this achieves the result that the direction of flow of the curable compound is deflected strongly after impact. Starting from the point of impact, the curable compound is driven outward by the centrifugal force along the bottom and along the inside of the side wall of the face wheel. As soon as the curable compound has then reached the edge of the face wheel, particles of the curable compound are thrown at a high speed in the direction of the inside wall of the pipe and form a spray mist. As a result, the direction of flow of the curable compound along the wall of the face wheel is deflected in an arc shape, permitting a uniform distribution over the entire circumference. This very uniform flow also achieves the result in particular that the curable compound is distributed by the face wheel very uniformly in all directions and there is no preferential direction depending on the site of impact of the stream on the face wheel.

Development of a uniform flow of curable compound at the bottom of the face wheel is supported if the face wheel has a concave inside face. The transition between the concave bottom of the face wheel and the side wall of the face wheel should preferably be without edges so that the curable compound can flow essentially without resistance from the bottom of the face wheel onto the side wall of the face wheel. In other words, this means that there is no concrete line of transition between the bottom and the side wall of the face wheel.

Which centrifugal forces act on the curable compound along the flow path on the side wall of the face wheel depends to a significant extent on the angle of spread of the side wall relative to the central axis of the face wheel. The speed at which the particles of curable compound are thrown from the edge of the face wheel in the direction of the inside of the pipe is greater the larger the angle of spread. It has been found in experimental series that especially good coating results are achieved when the angle of spread α is approximately in the range between 20° and 70°. An angle of spread of approximately 50° in particular has proven to be especially suitable for coating.

Another important criterion for operation of the device according to this invention is the impact angle β at which the stream of curable compound strikes the inside of the face wheel and/or the drift shaft arranged at the bottom relative to the central axis of the face wheel. It has been found in experiments that the impact angle β should be approximately in the range of 30° to 70°, especially approximately 40°, to achieve good coating results.

It essentially does not matter which type of curable compound is used for coating the bottom. Especially stable and easily processable curable compounds are obtained when the curable compound is prepared by blending multiple material components, e.g., a system of a primary material and a suitable curing agent or hardener. These material components are then conveyed through separate lines to the spraying device, where they are mixed shortly before the actual spraying operation.

The spraying device may essentially have any desired design. One problem with processing curable compounds prepared from several components blended together is that the mixing zone between the point where the components are mixed together and the point where the components leave the nozzle should be as short as possible. Only in this way is it possible to process material systems having an extremely short pot life. In addition, due to the short mixing zone, the cleanup effort after the end of the spraying operation can be reduced. On the other hand, however, the mixing zone must be at least long enough to permit a sufficiently homogeneous blending of the components of the material.

Therefore, a spraying device is proposed which has a valve that can be operated by means of a nozzle needle and is arranged close to the nozzle opening, and has an operating and reset device for the nozzle needle. In the nozzle there is a nozzle channel opening into the nozzle orifice, with the nozzle needle being displaceably mounted in the channel. Boreholes through which the components to be combined flow into the nozzle channel are mounted at the sides of the nozzle channel. As soon as the nozzle needle is retracted to the extent that the boreholes are released, the components to be combined flow into the nozzle channel from a lateral direction under the delivery pressure and are mixed together thoroughly there because of the turbulence in the flow. The mixing zone to be implemented in this way for the components to be combined can therefore be made extremely short. As soon as the spraying operation is to be concluded, the nozzle needle is advanced forward in the nozzle channel at least until the boreholes are sealed.

It is especially advantageous here if the length of the nozzle needle is selected so that in a state of rest in which the boreholes for supplying the components of material are sealed, the nozzle needle is flush with the nozzle opening of the spray gun. This achieves the result that when the spray operation is ended due to the advance of the nozzle needle, the entire remaining amount of material components that are already mixed is forced out of the nozzle channel by the tip of the nozzle needle. If the fit between the diameter of the nozzle channel and the diameter of the nozzle needle is manufactured with a sufficient precision, then essentially no curable material will remain in the nozzle channel after advancing the nozzle needle, thus greatly simplifying cleaning of the spray device after the end of the spraying operation.

An especially uniform blending of the material components to be blended is achieved if the boreholes for supplying the material components are situated in the same plane and are arranged to run essentially at a right angle to the nozzle channel. In other words, the nozzle channels may have a small angle of attack. The diameter of the borehole according to a preferred embodiment is smaller than the diameter of the nozzle channel, so that the material components under pressure become depressurized on entering the nozzle channel, which thus promotes the mixing effect.

To achieve a high flow turbulence in blending of the material components in the nozzle channel, the axes of the boreholes may be arranged with a mutual offset. This measure also improves blending of the material components, so the required mixing zone can be shortened.

To also permit remote-controlled operation of the spray device when using the device according to this invention, it is especially advantageous if the nozzle needle can be operated by means of a pressure plunger with a reciprocal action and a shaft attached to it.

The whirling of the curable compound results in air turbulence in the interior of the pipe which can have negative effects on the coating results. To prevent or reduce this negative air turbulence, an element for producing a directed airflow may therefore be provided on the device. This element may be designed in the manner of a propeller, for example. This additional airflow is superimposed on the negative air turbulence, which is thus diminished or eliminated.

The method according to this invention is characterized in that the device is simultaneously advanced along the pipe at a certain rate of advance to produce the cloud of curable compound flung away by the centrifugal device. Due to this combined movement kinematics, a uniform coating on the inside surface along the pipe can be produced in the end result.

Especially good coating results are achieved if the curable compound cures with a pot life of a few seconds. In other words, this means that the curable compound has already cured immediately after striking the inside of the pipe, so that this reliably prevents any unwanted shifting of material, e.g., caused by wet drips, running down from the top of the pipe to the bottom of the pipe.

Such a short pot life can be achieved especially easily with multicomponent systems in which the curable compound is prepared from several material components, e.g., a primary substance and a hardener suitable for it.

To minimize the cleaning complexity after the end of the injection process, the various material components that are mixed together to form the curable compound should not come in contact with one another until immediately before forming the stream in the spraying device.

In experiments, curable compounds of 2-component plastic based on polyurethane and/or polyurea have proven to be especially suitable for use in the method according to this invention.

The rotational speed of the centrifugal device should be selected in a range from 2,000 rpm to 60,000 rpm as a function of the desired layer thickness, the rate of advance, the feed rate of the curable compound and the other properties of the curable compound. Most coating jobs can be performed with a rotational speed of approximately 10,000 rpm with good coating results.

In experiments, values from 50 bar to 500 bar have proven to be advantageous as the delivery pressure with which the curable compound and/or the components thereof are supplied to the spraying device.

To permit a flexible response to varying boundary conditions even during the spraying process, it is especially advantageous if the rotational speed of the centrifugal device and/or the distance between the spraying device and the centrifugal device and/or the speed of the stream of curable compound can be varied as a function of other process parameters. Conceivable process parameters include in particular the desired layer thickness, the diameter of the pipe, the rate of advance of the device and/or the material properties of the curable compound. In particular it is also conceivable to provide control zones or control loops to regulate and/or control one or more process parameters as guide parameters. For example it would be conceivable to measure the layer thickness produced by using suitable video analysis and to increase and/or decrease for example the rotational speed of the centrifugal device or the speed of the stream of curable compound as a function of the desired layer thickness in order to thereby approximate the actual layer thickness to the ideal layer thickness.

The drawings illustrate one embodiment of this invention which is explained in greater detail below.

They show:

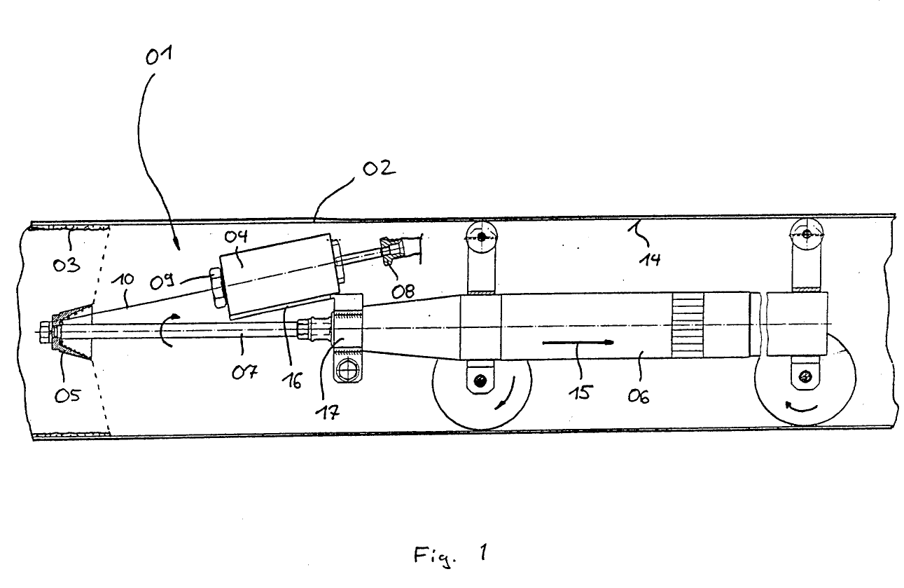

FIG. 1 a device for interior coating of a pipe shown in a cross-sectional view;

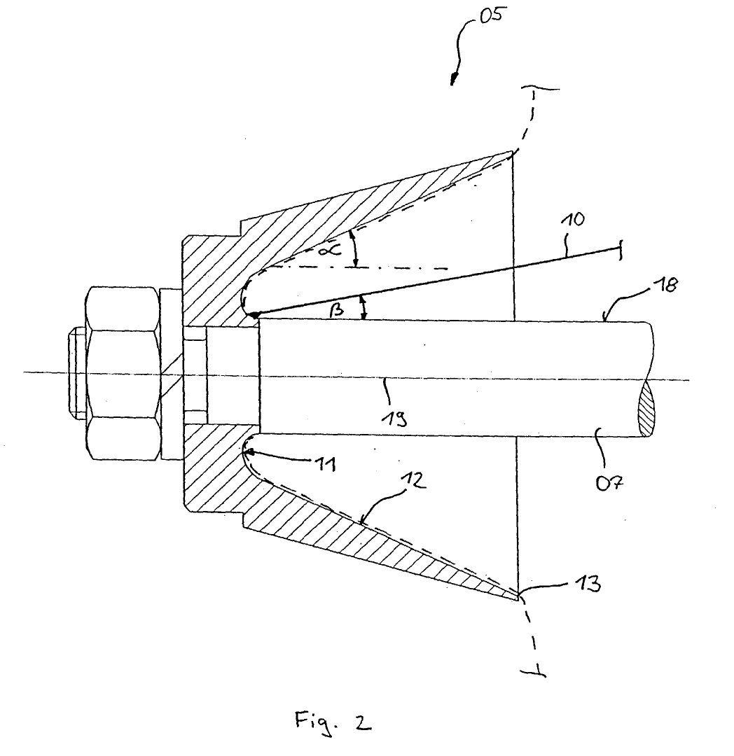

FIG. 2 the face wheel of the device illustrated in FIG. 1 shown in a longitudinal section;

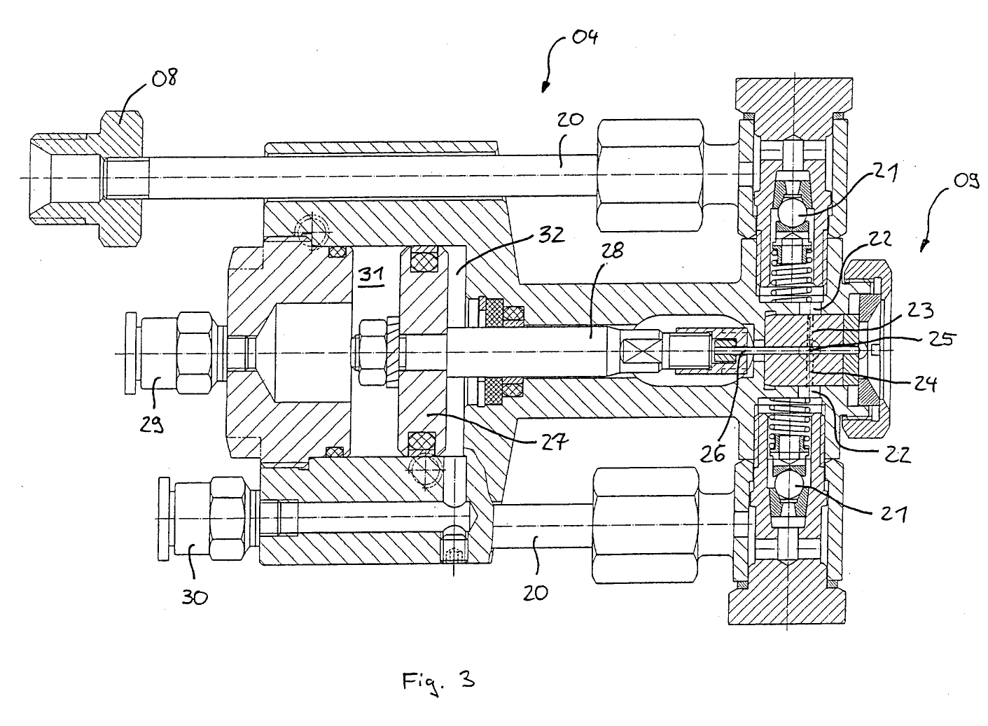

FIG. 3 the spraying device of the device illustrated in FIG. 1 shown in a longitudinal section;

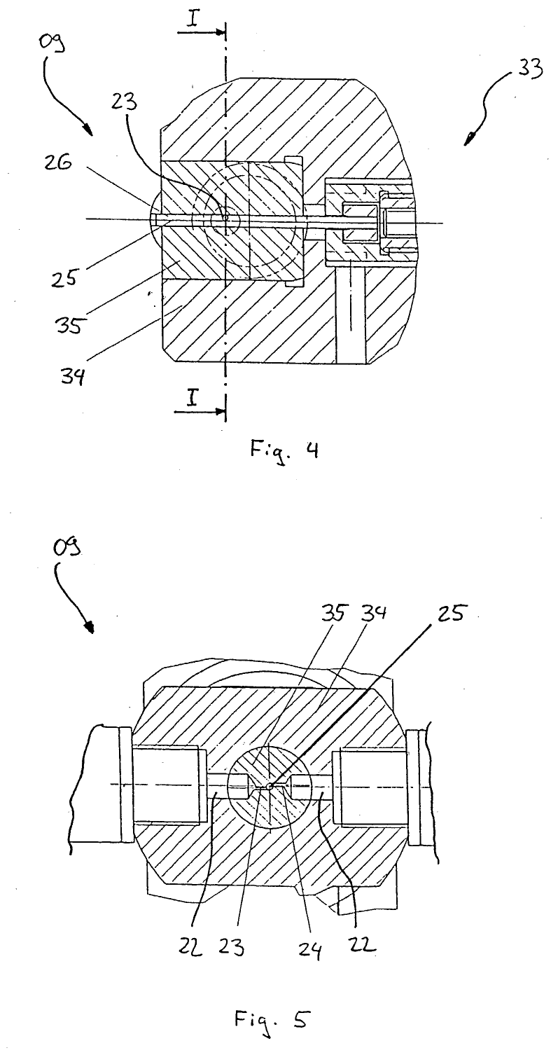

FIG. 4 the nozzle of the spraying device according to FIG. 3 shown in an enlarged longitudinal sectional view;

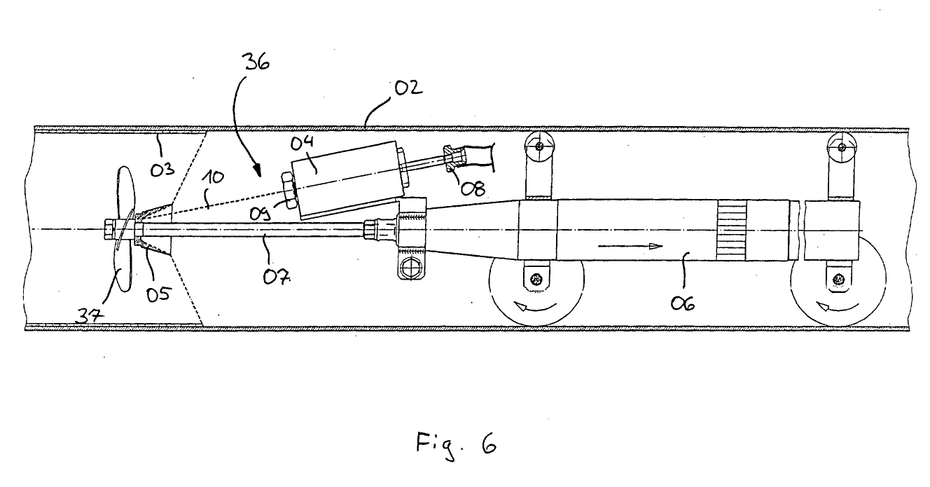

FIG. 5 the nozzle according to FIG. 4 in a cross section along sectional line I-I.

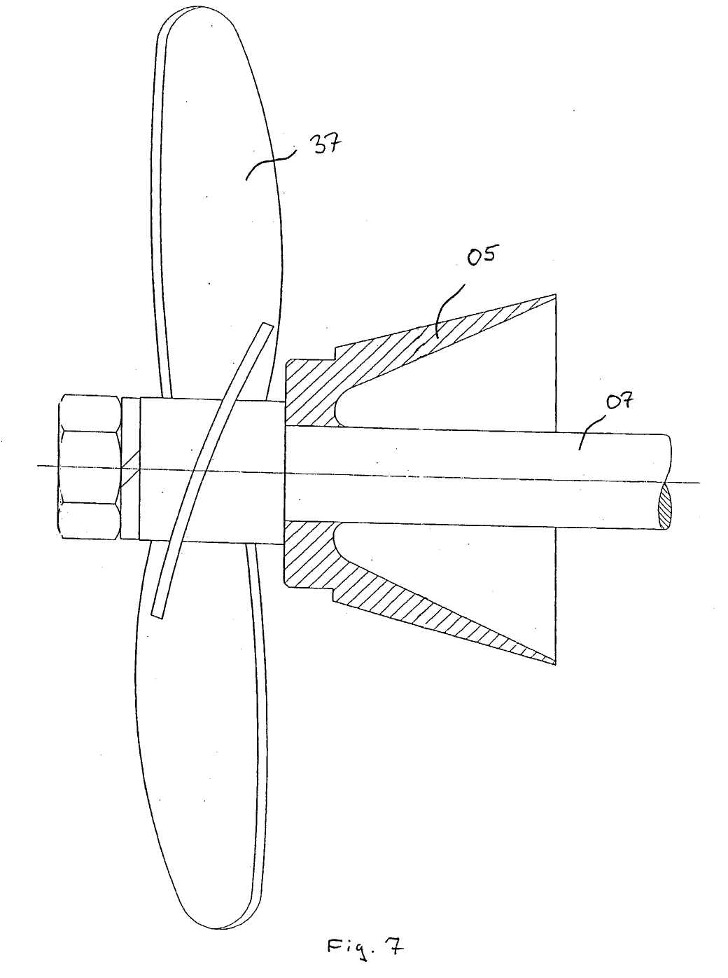

FIG. 6 a second embodiment of a device for interior coating of a pipe shown in a cross-sectional view;

FIG. 7 the centrifugal device having a propeller of the device illustrated in FIG. 6 shown in a cross-sectional view.

Device 01 shown schematically in FIG. 1 is used for interior coating of a pipe 02 with a curable compound 03. Device 01 is composed essentially of a spraying device 04, a centrifugal device 05 designed in the manner of a face wheel and a drive motor 06 driven by compressed air, its rotational driving movement being transmitted by drive shaft 07 to the centrifugal device 05.

For operation of device 01, two supply lines (not shown in FIG. 1) are each attached to spraying device 04 at a connecting flange 08. The spraying device 04 is supplied with a polyurethane primary material under pressure and a hardening compound also under pressure through these two supply lines, with these components being mixed in the spraying device 04 to form a curable compound. A nozzle 09 is arranged on the front side of the spraying device 04 and a directed stream 10 of the curable compound can leave the spraying device 04 through this nozzle.

Stream 10 of curable compound is directed at the concave bottom (see FIG. 2) of face wheel 05. By driving the drive motor 06, the centrifugal device 05 is driven to rotate at a rotational speed of approximately 10,000 rpm, for example. On the basis of this rotational movement of the centrifugal device 05, a high centrifugal force acts on the curable compound after striking bottom 11 of face wheel 05, driving the curable compound outward along the bottom 11 and then along the inside 12 of the side wall (see FIG. 2). As a result, the centrifugal force produces a flow of curable compound emanating from the inside area of the bottom 11 and ending at the edge 13 (see FIG. 2) of the face wheel 05. As soon as the flow of curable compound has reached the edge 13 and thus is no longer supported from the outside by the wall of the face wheel 12, the curable compound is thrown outward in the form of finely divided particles in the direction of the inside wall 14 of pipe 02, which is indicated with dash-dot lines in FIG. 1. As a result, a spray mist in the form of a truncated cone with a very uniform distribution of material is formed due to the rotational movement of the centrifugal device 03, so that coating 03 is deposited with a very uniform layer thickness on the inside wall 14.

The device 01 can move axially in pipe 02 and at the same time is moved in the direction of arrow 15 to operate the spraying device 04 and the rotational movement of the centrifugal device 05. This makes it possible to produce a continuous interior coating 03 with a very uniform layer thickness on the inside wall 14. If necessary, the device may also be moved back and forth in alternation to build up a sufficient layer thickness, e.g., at the pipe transitions.

The spraying device 04 is mounted on a strap 16 which can be secured on the housing of the drive motor 06 by means of a ring flange 17. Elongated holes, for example, may be provided on the strap 16 so that the spraying device 04 can be secured in different positions relative to the centrifugal device 05. This permits an adjustment of the distance between the spraying device 04 and the centrifugal device 05. Embodiments, e.g., with corresponding servomotors with which the distance between the spraying device 04 and the centrifugal device 05 can be varied by remote control even during the coating operation are also conceivable.

In addition, the rotational speed of the drive motor 06 and the delivery pressure for delivering the components to be mixed into the spraying device 04 may be varied before and during the spraying operation.

FIG. 2 shows the centrifugal device 05 in a cross-sectional view mounted at the tip of the drive shaft 07. It can be seen here that the bottom 11 of face wheel 05 has a concave curvature. The transitions from the bottom 11 to the outside diameter 18 of the drive shaft 07 and/or the inside 12 of the side wall of the face wheel 05 are designed without edges.

If the stream 10 of curable compound indicated in FIG. 2 strikes the outside diameter 18 of the drive shaft 07 and/or the inside diameter of the bottom 11, then due to the concave shape of the bottom 11 and the edge-free transitions between the outside diameter 18, the bottom 11 and the inside 12 of the side wall, a uniform flow of the curable compound under the influence of the centrifugal force is made possible.

It is especially advantageous if the stream 10, as indicated schematically in FIG. 2, strikes strikes the centrifugal device 05 precisely at the transition between the outside diameter 18 and the bottom 11. As a result, this achieves the effect that essentially all the curable compound is driven completely outward. Unwanted hardening of the curable compound on the centrifugal device 05 can thus be avoided.

In FIG. 2, the angle of spread α on the inside 12 of the face wheel 05 and the impact angle β with which the stream 10 strikes the centrifugal device 05 relative to the center axis 19 are indicated schematically.

The spraying device 04 which is only indicated schematically in FIG. 1 is shown in a detailed longitudinal sectional view in FIG. 3. Two connecting flanges 08 are provided on device 04, only one of which is shown in FIG. 3. A hose line is attached to this connecting flange 08 so that a polyurethanic primary material on the one hand and a suitable curing agent on the other hand are conveyed through these hose lines to the spraying device 04 under a high delivery pressure. The two material components are conveyed separately from one another through non-return valves 21 to two antechambers 22 and the connecting tubes 20. The two antechambers 22 are each connected to a nozzle channel 25 through a borehole 23 and 24 respectively (see FIG. 5). One nozzle needle 26 is displaceably mounted in the nozzle channel 25, whereby the diameter of the nozzle channel 26 is adapted to the inside diameter of the nozzle channel 25 so that the boreholes 23 and 24 can be sealed by the nozzle needle 26.

To operate the nozzle needle 26, a reciprocal action pressure plunger 27 is provided, connected by a shaft 28 to the nozzle needle 26. Through the compressed air connections 29 and 30, the pressure chambers 31 and 32 provided upstream and downstream from the pressure plunger 27 may be acted upon by compressed air so that the pressure plunger 27 is displaced axially together with the nozzle needle 26 when a corresponding differential pressure is established.

The design of nozzle 09 with nozzle channel 25, nozzle needle 26 and boreholes 23 and 24 for supplying the two material components is shown on an enlarged scale in FIGS. 4 and 5. The components together form a valve 33 by means of which the stream 10 of curable compound can be blocked off. It can be seen here that the nozzle needle 26 is just long enough to end at the nozzle orifice 33 in the resting state. The two boreholes 23 and 24 run in a plane at a right angle to nozzle channel 25, as shown in FIG. 5, where the diameter of the boreholes 23 and 24 is smaller than that of the nozzle channel 25. In addition, the axes of the boreholes 23 and 24 are offset relative to one another to produce a turbulence in the material components to be mixed in the nozzle channel 25. With regard to the structure, valve 33 is formed by a base body 34 and a hard metal insert 35 into which the boreholes 23 and 24 as well as the nozzle channel 25 are cut. The nozzle needle 26 is also made of hard metal or as an alternative it may be made of ceramic.

FIG. 6 shows a second embodiment 36 of a device for interior coating in a cross-sectional view. The design of device 36 corresponds essentially to the design of device 01. In addition, a propeller 37 to produce a directed airflow is also mounted at the end of the drive shaft 07. Propeller 37 has four blades.

FIG. 7 shows the centrifugal device 05 with propeller 37 on an enlarged scale.

### List of Reference Notation

01 device

02 pipe

03 interior coating

04 spraying device

05 centrifugal device

06 drive motor

07 drive shaft

08 connecting flange

09 nozzle

10 stream

11 bottom (centrifugal device)

12 inside of the side wall (centrifugal device)

13 edge (centrifugal device)

14 inside wall (pipe)

15 arrow (device)

16 strap

17 ring flange

18 outside diameter (drive shaft)

19 central axis (centrifugal device)

20 feed line

21 nonreturn valve

22 antechamber

23 borehole for supplying a first component

24 borehole for supplying a second component

25 nozzle channel

26 nozzle needle

27 pressure plunger

28 shaft

29 compressed air connection

30 compressed air connection

31 pressure chamber

32 pressure chamber

33 valve

34 base body

35 hard metal insert

36 device

37 propeller

1. A device (01) for coating the interior wall (14) of a pipe (02) with a curable compound, a spraying device (04) being provided on the device (01) by means of which a directed stream (10) of curable compound can be produced,
characterized in that,
a centrifugal device (05) which can be driven to rotation is provided on the device (01), the stream (10) of curable compound being directed at the centrifugal device (05) so that the curable compound is thrown against the inside wall (14) of the pipe (02) by the centrifugal device (05) due to the centrifugal force caused by rotation.

2. The device according to claim 1, characterized in that a drive motor (06) driven with compressed air in particular or something similar is provided for driving the centrifugal device (04).

3. The device according to claim 1 or 2, characterized in that the distance between the centrifugal device (05) and the spraying device (04) is variable.

4. The device according to one of claims 1 through 3, characterized in that the rotational speed of the centrifugal device (05) is variable.

5. The device according to one of claims 1 through 4, characterized in that the flow rate of the stream (10) of curable compound is variable, in particular by varying the delivery pressure.

6. The device according to one of claims 1 through 5, characterized in that the device (01) is movable along the pipe (02) by means of a conveyer device, in particular by remote control.

7. The device according to one of claims 1 through 6, characterized in that an observation unit, in particular a video camera is provided on the device.

8. The device according to one of claims 1 through 7, characterized in that the centrifugal device (05) is designed in the manner of a face wheel, which can be driven to rotate about the midpoint of its bottom (11).

9. The device according to claim 8, characterized in that the stream (10) of curable compound strikes the inside of the face wheel (05).

10. The device according to claim 9, characterized in that the stream (10) of curable compound strikes essentially the bottom (11) of the face wheel (05) and/or the drive shaft (07) coming out of the bottom (11) of the face wheel.

11. The device according to one of claims 8 through 10, characterized in that the bottom (11) of the face wheel (05) has a concave inside surface.

12. The device according to one of claims 8 through 11, characterized in that the side wall of the face wheel (05) has an angle of spread (a) of 20° to 70°, in particular approximately 50°, relative to the central axis (19) of the face wheel (05).

13. The device according to one of claims 8 through 12, characterized in that the stream (10) of curable compound strikes the face wheel (05) at an angle of impact (β) of 30° to 70°, in particular approximately 40°, relative to the central axis (19) of the face wheel (05).

14. The device according to one of claims 1 through 13, characterized in that at least two material components, in particular a primary material and a curing agent suitable for it, can be mixed in the spraying device (04) to produce the stream (10) of curable compound.

15. The device according to one of claims 1 through 14, characterized in that a directed round stream and/or a flat stream of curable compound can be produced with the spraying device (04).

16. The device according to one of claims 1 through 15, characterized in that the spraying device (04) has a valve (33) which can be operated by means of a nozzle needle (26) arranged close to a nozzle orifice, and has an actuating and reset device (27, 28, 29, 30, 31, 32) for the nozzle needle (26), a nozzle channel (25) opening in the nozzle orifice in the nozzle (09) with the nozzle needle (26) displaceably mounted in this nozzle channel, and the nozzle channel (25) having at least one, in particular two boreholes (23, 24) which open into the nozzle channel (25) at the side and are used to supply components of the curable compound, these boreholes being closable by a nozzle needle (26) whose diameter is matched to the diameter of the nozzle channel (25).

17. The device according to claim 16, characterized in that the length of the nozzle channel (26) is selected so that in the resting state it is flush with the nozzle opening of the valve (33).

18. The device according to claim 16 or 17, characterized in that the valve (33) at the same time forms the nozzle opening of the spray device (04).

19. The device according to one of claims 16 through 18, characterized in that the nozzle (09), in particular the nozzle needle (26) and the component (35) forming the nozzle channel are made at least in part of a hard metal or ceramic.

20. The device according to one of claims 16 through 19, characterized in that the boreholes (23, 24) are arranged in the same plane and run essentially at a right angle to the nozzle channel (25).

21. The device according to one of claims 16 through 20, characterized in that the diameter of the boreholes (23, 24) is smaller than the diameter of the nozzle channel (25).

22. The device according to one of claims 16 through 21, characterized in that the axes of the boreholes (23, 24) are offset relative to one another.

23. The device according to one of claims 16 through 22, characterized in that the nozzle needle (26) is displaceable by means of a shaft (28) operated by a reciprocal action pressure plunger (27).

24. The device according to one of claims 1 through 23, characterized in that an element for producing a directed airflow is provided on the device.

25. The device according to claim 24, characterized in that the element for producing a directed airflow is designed in the manner of a propeller.

26. The device according to claim 25, characterized in that the propeller is mounted upstream from the centrifugal device (05) on the drive shaft (07).

27. A method of interior coating of a pipe (02) with a curable compound characterized in that a directed stream (10) of curable compound is produced with a spraying device (04),
the stream (10) of the curable compound is directed at a centrifugal device (05),
the curable compound is thrown by the centrifugal device (05) against the inside wall (14) of the pipe (02) because of the centrifugal force created by the rotation,
whereby at the same time the centrifugal device (05) and the spraying device (04) are moved with a certain rate of advance along the pipe (02) produce a coating (03) on the inside wall (14) along the pipe (02).

28. The method according to claim 27, characterized in that the curable compound cures with a pot life of a few seconds.

29. The method according to claim 27 or 28, characterized in that the curable compound is prepared by blending two material components, in particular a primary material and a curing agent suitable for it.

30. The method according to claim 29, characterized in that a two-component plastic based on polyurethane and/or polyurea is used as the curable compound.

31. The method according to claim 29 or 30, characterized in that the two material components are mixed only immediately before forming the stream in the spraying device.

32. The method according to one of claims 27 through 31, characterized in that the centrifugal device (05) rotates at a rotational speed of 2,000 rpm to 60,000 rpm.

33. The method according to one of claims 27 through 32, characterized in that the curable compound or components thereof are conveyed into the spraying device (05) at a delivery pressure of 50 bar to 500 bar.

34. The method according to one of claims 27 through 33, characterized in that the rotational speed of the centrifugal device (05) and/or the distance between the spraying device (04) and the centrifugal device (05) and/or the speed of the stream (10) of curable compound are each variable individually or jointly as a function of the desired layer thickness of the interior coating (03) and/or the pipe diameter of the pipe (02) to be coated and/or the rate of advance of the device (01) and/or the material properties of the curable compound.

35. The method according to one of claims 27 through 34, characterized in that a directed airflow is produced in the area of the centrifugal device (05), in particular by driving a propeller.
